(19) United States
(12) Patent Application Publication
(10) Pub. No.: US 2022/0185591 A1
(43) Pub. Date: Jun. 16, 2022

(54) Method and System for Enabling a Delivery of a Motor-Driven Processing Machine and/or a Battery Pack for Supplying a Processing Machine with Electrical Drive Power at a Delivery Point

(71) Applicant: Andreas Stihl AG & Co. KG, Waiblingen (DE)

(72) Inventors: Robert BOEKER, Waiblingen (DE); Kerstin Weiss, Murrhardt (DE); Mario Haefele, Winnenden (DE)

(21) Appl. No.: 17/643,447

(22) Filed: Dec. 9, 2021

(30) Foreign Application Priority Data
Dec. 10, 2020 (EP) 20213076.1

(51) Int. Cl. B65G 43/00

(52) U.S. Cl. CPC B65G 43/00; B65G 2203/0216

(57) ABSTRACT

A method for enabling a delivery of a motor-driven processing machine and/or a battery pack for supplying a processing machine with electrical drive power to a delivery point is provided. A transmitting device is arranged on and/or in the processing machine and/or the battery pack. The transmitting device is designed for the wireless transmission of operating and/or status data of the processing machine and/or the battery pack and an identifier. The method includes the steps of: at least identifying the processing machine and/or the battery pack and/or the transmitting device based on the transmitted identifier; and enabling the delivery of the processing machine and/or the battery pack at the delivery point depending on a result of at least the identification.

### CROSS REFERENCE TO RELATED APPLICATION

This application claims priority under 35 U.S.C. § 119 from European Patent Application No. 20213076.1, filed Dec. 10, 2020, the entire disclosure of which is herein expressly incorporated by reference.

### BACKGROUND AND SUMMARY OF THE INVENTION

The invention relates to a method and system for enabling a delivery of a motor-driven processing machine, and/or a battery pack for supplying a processing machine with electrical drive power, to a delivery point.

The invention is based on the provision of a method and a system for enabling a delivery of a motor-driven processing machine and/or a battery pack for supplying a processing machine with electrical drive power at a delivery point, wherein the method and the system, in particular in each case, have improved properties.

This object is achieved according to the invention by a method and a system in accordance with the independent claims. Advantageous extensions and/or embodiments of the invention are specified in the dependent claims.

The method according to the invention, which in particular is automatic, is designed or configured or provided to enable or approve or grant or authorize, in particular automatically, a delivery of a motor-driven processing machine and/or a battery pack for supplying a processing machine, in particular the processing machine, with electrical drive power to, in particular into, an in particular electrical delivery point. An in particular electrical transmitting device is arranged on and/or in the processing machine and/or the battery pack, in particular fastened thereto. The transmitting device is designed or configured for the, in particular automatic, wireless transmission of operating and/or status data, in particular of a value of the operating and/or status data, of the processing machine and/or the battery pack, and an, in particular unique, identifier, in particular a value of the identifier. The method has or comprises the steps: a) at least identifying, in particular automatically identifying, the processing machine and/or the battery pack and/or the transmitting device based on the transmitted identifier; b) enabling, in particular automatically enabling, or approving or granting or authorizing the delivery of the processing machine and/or the battery pack, in particular using the transmitting device, at the delivery point depending on a result, in particular positive result, of at least the identification.

The method, in particular the identification, allows a delivery of unknown processing machines and/or unknown battery packs to be avoided.

Additionally or alternatively, the method, in particular the identification based on the identifier sent by means of the transmitting device arranged on and/or in the processing machine and/or battery pack, allows the delivery to be simple and uncomplicated. In particular, the processing machine and/or the battery pack need not or cannot be identified based on an identifier sent by means of a remote or separate identification device or manually entered, in particular by a deliverer.

Further, additionally or alternatively, the method allows a synergy effect or additional use of the transmitting device designed for wireless transmission of the operating and/or status data and the identifier, in particular allowing an assignment of the in particular transmitted operating and/or status data to the processing machine and/or the battery pack. In particular, the delivery may be for cleaning, maintenance and/or repair and/or return at the end of a rental and/or a shared use of the processing machine and/or battery pack. Operating and/or status data can be helpful for this purpose.

Further, in addition or alternatively, the method allows the delivery to be made outside the opening hours of a workshop, in particular the one performing the cleaning, maintenance and/or repair, and/or of a rental office and/or sharing service provider.

This enables a high level of convenience for the deliverer.

In particular, the processing machine and/or the battery pack can be delivered by a, in particular the, deliverer.

The processing machine can be a hand-held, in particular ground-guided and/or hand-carried, processing machine. An in particular hand-held, in particular hand-carried, processing machine can mean that the processing machine can have a maximum mass of 50 kilograms (kg), in particular a maximum of 20 kg, in particular a maximum of 10 kg. In addition or alternatively, the processing machine may have an electric drive motor and/or an internal combustion drive motor.

The delivery point may be a drop-off and collection point, in particular for collecting a, in particular the, processing machine and/or a, in particular the, battery pack. In addition or alternatively, the delivery point may be an in particular stationary drop-off station or a mobile drop-off point, in particular on and/or in a pickup, box wagon or bus.

The processing machine and/or the battery pack can comprise the transmitting device.

The transmitting device can have a transmitting antenna and be designed for wireless transmission of the operating and/or status data and the identifier by means of the transmitting antenna, in particular the same one.

The method can comprise, in particular, the step: wirelessly transmitting, in particular automatically and/or repeatedly, in particular periodically, transmitting the identifier, in particular and the operating and/or status data, by means of the transmitting device. In addition or alternatively, the method can comprise, in particular, the step: wirelessly receiving, in particular automatically receiving, the transmitted identifier, in particular and the transmitted operating and/or status data, in particular after the transmission and/or before step a).

Step b) can be executed after step a).

The identifier and/or the operating and/or status data can be deposited or stored in a memory of the processing machine and/or the battery pack and/or the transmitting device. In addition or alternatively, the identifier can be preset at the factory.

The transmitting device can be installed on and/or in the processing machine and/or the battery pack at the factory or retrofitted. In addition or alternatively, the transmitting device can be a part of the processing machine and/or the battery pack, in particular wherein the transmitting device can be connected, in particular mechanically, to other parts of the processing machine and/or the battery pack. Alternatively, the transmitting device can be disconnected or separate from the processing machine and/or the battery pack. This allows the transmitting device to be retrofitted to and/or in the processing machine and/or the battery pack.

In the event of a negative result of at least the identification, the delivery need not or may not be enabled.

In an extension of the invention, step a) comprises or includes: checking, in particular automatically checking, or verifying an authorisation to enable the delivery based on the transmitted identifier. Step b) comprises or includes: enabling the delivery depending on an, in particular positive, result of the check. This allows a delivery of unauthorized processing machines and/or unauthorized battery packs to be avoided. In particular, the authorisation can be an enable or approval authorisation. In addition or alternatively, the authorisation may be based on a reservation or a registration or a prior notification of the delivery of the processing machine and/or the battery pack. Further, in addition or alternatively, the authorisation can be based on a workshop order, a rental agreement and/or a sharing agreement for the processing machine and/or the battery pack. Further, in addition or alternatively, the authorisation can be based on a known presence, in particular a depositing or storage, of the identifier or identifier information based on the identifier. Further, in addition or alternatively, the delivery need not or may not be enabled in the event of a negative result of the check.

In an extension of the invention, step a), in particular the identification and/or checking, comprises or includes: comparing, in particular automatically comparing, the transmitted identifier or identifier information based on the transmitted identifier, in particular a value of the identifier information, with a number, in particular deposited or stored, in particular a plurality, of items of comparison information, in particular values of the comparison information items, in particular of a number, in particular a plurality, of comparison identifiers, in particular values of the comparison identifiers. Step b) comprises or includes: enabling the delivery depending on a, in particular positive, result of the comparison. This allows the delivery of non-deposited or non-stored processing machines and/or non-deposited or non-stored battery packs to be avoided. In particular, the number of items of comparison information may be based on a reservation or registration or prior notification of the delivery of the processing machine and/or the battery pack. In addition or alternatively, the number of items of comparison information can be based on a workshop order, a rental agreement, and/or a sharing agreement for the processing machine and/or the battery pack. Further, in addition or alternatively, the number of items of comparison information can be based on a known presence, in particular a depositing or storage, of the identifier or the identifier information. Further, in addition, or alternatively, the number of items of comparison information can be deposited or stored in a database, in particular an electronic database. Further, in addition or alternatively, in the event of a negative result of the comparison the delivery need not or may not be enabled.

In an extension of the invention, the delivery point comprises or has at least one delivery opening and at least one closure of the delivery opening. Step b) comprises or includes: enabling, in particular automatically enabling, an opening and/or closing, in particular a sealing and/or by the deliverer, and/or opening, in particular automatically opening, and/or closing, in particular automatically closing and/or sealing, of the closure, in particular a lock of the closure, depending on the, in particular positive, result of the identification. This prevents unauthorized removal of a delivered processing machine and/or a delivered battery pack. In particular, the delivery point can comprise at least one delivery box, in particular a locker, wherein the delivery box may comprise or have the delivery opening and/or the closure. In addition or alternatively, the closure may have, in particular be, a door and/or a flap. Further, in addition or alternatively, depending on a negative result of the identification, the opening and/or closing of the closure need not or may not be enabled and/or the opening and/or closing of the closure need not or may not be performed.

In an extension of the invention, the processing machine is made of a number of, in particular different, processing machines with different machine sizes and/or the battery pack is made of a number of, in particular different, battery packs with different pack sizes. The delivery point comprises or has a plurality of in particular closable, in particular lockable, delivery boxes with different box sizes. The method comprises or includes, in particular the step: allocating, in particular automatically and/or logically allocating or assigning, in particular at least one, in particular free, delivery box, in particular of the plurality of delivery boxes, with a box size equal to or greater than a machine size of the processing machine and/or a pack size of the battery pack based on the transmitted identifier, in particular to the processing machine and/or the battery pack. This allows optimal usage of the space at the delivery point. In particular, the delivery point may be a locker unit, in particular a locker unit system. Additionally or alternatively, the device size and/or the pack size and/or, in particular therefore, the box size can be determined, in particular identified, based on the identifier. The delivery box can be allocated based on the determined box size. Further in addition or alternatively, box information about the allocated delivery box, in particular and the processing machine and/or the battery pack for the delivery box, in particular information that can be comprehended by a deliverer, can be output and/or transmitted, especially in the area of the delivery point. In particular, the box information can be output visually and/or acoustically. Further in addition or alternatively, the allocated delivery box, in particular its closure, can be opened.

In an extension, in particular an embodiment of the invention, the transmitting device is designed or configured for, in particular automatic, wireless transmission of a signal comprising the identifier, in particular a value of the identifier, in particular and the operating and/or status data. The method comprises or includes, in particular the step: detecting, in particular automatically detecting, the delivery by means of, in particular automatically, detecting a presence of the processing machine and/or of the battery pack, in particular using the transmitting device, within an, in particular closable, in particular lockable, delivery area of the delivery point, in particular the allocated delivery box, depending on an, in particular automatic, reception of the transmitted signal, in particular a signal strength and/or direction, in particular a value of the signal strength and/or direction, or a signal quantity, in particular a value of the signal quantity of the received signal corresponding to the signal strength and/or direction. This allows the method to be successfully completed or terminated. In particular, depending on the detected delivery, in particular the recognized presence, the closing of the closure can be enabled and/or the closure and/or the delivery box may be closed. In addition or alternatively, the method can comprise, in particular, the step: wirelessly transmitting, in particular automatically and/or repeatedly, in particular periodically transmitting, the signal by means of the transmitting device. Further additionally or alternatively, the method can comprise, in particular, the step: wirelessly receiving, in particular automatically receiving, the transmitted signal, in particular and detecting the signal strength and/or direction or the signal quantity of the received signal. Further additionally, the signal can be transmitted and/or received within the delivery area. For further details, reference is also made to the relevant specialist literature.

In an extension of the invention the processing machine is a garden, forestry, construction and/or ground processing machine, in particular a saw, a high-level pruner, a hedge trimmer, a hedge cutter, a woodcutter, pruning shears, a blower, a leaf blower, a suction device, a garden vacuum cleaner, a cleaning device, a pressure washer, a spray and/or sprinkler device, a sweeper, a sweeping roller, a brush sweeper, a lawn mower, a grass cutter, a vertical cutter, a brush saw, an angle grinder or a stone cutter. Thus, the processing machine can belong to the number of processing machines with different machine sizes.

In an extension of the invention, the method comprises or includes, in particular, the steps: determining, in particular automatically determining and/or identifying, delivery information, in particular a value of the delivery information, in particular workshop, rental and/or sharing information, in particular a value of the workshop, rental and/or sharing information, which in particular can be comprehended by the deliverer, based on the transmitted operating and/or status data, and outputting, in particular automatically outputting, and/or transmitting, in particular automatically and/or wirelessly transmitting, the determined delivery information, in particular in the area of the delivery point and/or during or at the same time as the delivery. This allows the deliverer to receive a feedback or a summary of the cleaning, maintenance and/or repair and/or rental and/or sharing of the processing machine and/or battery pack. This allows a high level of convenience for the deliverer. In particular, the method can comprise, in particular the step: wirelessly transmitting, in particular automatically and/or repeatedly, in particular periodically, the operating and/or status data by means of the transmitting device. In addition or alternatively, the method can comprise, in particular, the step: wirelessly receiving, in particular automatically receiving, the transmitted operating and/or status data. Further additionally, the sending and/or receiving of the operating and/or status data can be in the area of the delivery point. Further additionally or alternatively, the delivery information can be output visually and/or acoustically. Further in addition or alternatively, the transmission can take place to an in particular electrical and/or external and/or separate, mobile or portable terminal, such as e.g. a smartphone or a smartwatch. Further in addition or alternatively, the delivery information can relate to a spare part for the processing machine and/or the battery pack, an in particular estimated duration of the workshop stay, a warranty acceptance or a self-acceptance of the cleaning, maintenance and/or repair, a cost estimate for the cleaning, maintenance and/or repair, an invoice for the rental and/or sharing, and/or to the fact that the processing machine and/or the battery pack is/are to be switched off, in particular to be deactivated. In particular, the spare part can be ordered based on the transmitted operating and/or status data, or an order for the spare part can be triggered or initiated based on the transmitted operating and/or status data.

In an extension of the invention, an in particular electrical device is arranged on and/or in the processing machine and/or the battery pack, in particular fastened thereto. The device comprises or has an, in particular electrical, acquisition and/or evaluation device, in particular and an, in particular electrical, determination device, and the transmitting device. The acquisition and/or evaluation device is designed or configured to acquire at least one, in particular physical, operating variable, in particular a value of the operating variable, in particular automatically and/or repeatedly, in particular periodically, wherein the operating variable depends on an operating state of the processing machine and/or the battery pack, and to evaluate the acquired operating variable to determine the operating data, in particular automatically. Additionally or alternatively, the acquisition and/or evaluation device is designed or configured to acquire the operating data, in particular automatically and/or repeatedly, in particular periodically. The determination device is designed or configured to determine, in particular automatically, the status data of the processing machine and/or the battery pack based on the determined and/or acquired operational data. In particular, the processing machine and/or the battery pack can comprise the device. In addition or alternatively, the device can be factory fitted or retrofitted on and/or in the processing machine and/or the battery pack. Further additionally or alternatively, the device can be part of the processing machine and/or battery pack, in particular wherein the device can be connected, in particular mechanically, to other parts of the processing machine and/or battery pack. Alternatively, the device may be disconnected or separate from the processing machine and/or the battery pack. This allows the device to be retrofitted to and/or in the processing machine and/or the battery pack. Further in addition or alternatively, the device can be in direct or immediate contact with the processing machine and/or the battery pack when arranged on and/or in the processing machine and/or the battery pack. Further in addition or alternatively, the device can comprise an, in particular electrical, operating and/or status data memory, wherein the operating and/or status data memory can be designed for storing, in particular automatically, the determined and/or acquired operating and/or status data. For further details, reference is also made to the relevant specialist literature.

In an extension of the invention, the operating and/or status data comprise or include usage data, in particular values of the usage data, and/or a runtime, in particular a value of the runtime, and/or a rotation speed, in particular a value of the rotation speed, in particular rotation speed statistics, in particular a value of the rotation speed statistics, and/or a current, in particular a value of the current, and/or a voltage, in particular a value of the voltage, and/or a temperature, in particular a value of the temperature, and/or a in particular regular determination status, in particular a value of the determination status, and/or an in particular urgent maintenance status, in particular a value of the maintenance status, and/or a fault status, in particular an acute fault status, in particular a value of the fault status. Such operating and/or status data is useful for the cleaning, maintenance and/or repair and/or the rental and/or sharing of the processing machine and/or battery pack. For further details, reference is also made to the relevant specialist literature.

In an extension of the invention, the identifier comprises or includes a serial number, in particular a value of the serial number, and/or a MAC address, in particular a value of the MAC address, and in particular is a serial number and/or a MAC address. In particular, the identifier information based on the, in particular transmitted, identifier can be a type of the serial number and/or the MAC address. For further details, reference is also made to the relevant specialist literature.

In an extension of the invention, the transmitting device is designed or configured for the in particular automatic wireless transmission of a signal, in particular the signal comprising the identifier, in particular a value of the identifier, in particular and the operating and/or status data. The signal is a radio signal, in particular a Bluetooth Low Energy signal and/or a ZigBee signal and/or has a short range, in particular a maximum range of 10 m (meters). In particular, the method can comprise, in particular the step: wirelessly transmitting, in particular automatically and/or repeatedly, in particular periodically transmitting, the signal by means of the transmitting device. In addition or alternatively, the method can comprise, in particular, the step: wirelessly receiving, in particular automatically receiving, the transmitted signal. For further details, reference is also made to the relevant specialist literature.

In an extension of the invention, the method comprises or includes, in particular the step/s: wirelessly receiving, in particular automatically receiving, the transmitted identifier, in particular a value of the identifier, in particular and the transmitted operating and/or status data, in a reception area of the delivery point, in particular by means of an in particular electrical receiving device, in particular an in particular electrical gateway. The receiving device is arranged in the region of the delivery point. Additionally or alternatively: transmitting, in particular automatically transmitting, the in particular received identifier, in particular a value of the identifier, in particular and the transmitted operating and/or status data, to an, in particular electrical and/or external and/or remote or separate, identification and/or enabling control or administration or management system, in particular by the receiving device and/or via the gateway. Step a) and/or step b) is/are performed at least partially, in particular completely, by means of the identification and/or enabling control device, in particular automatically. Further additionally or alternatively: transmitting, in particular automatically transmitting, an enable or approval command, in particular a value of the enable command, in particular by the identification and/or enabling control device and/or via the gateway, to the delivery point, in particular a delivery control device of the delivery point. Further additionally or alternatively, the method is executed, in particular automatically, by means of a, in particular at least one, in particular the, gateway of an, in particular the, identification and/or enabling control device and/or the delivery point, in particular by a delivery control device of the delivery point, in particular and an in particular electrical and/or external and/or remote or separate, workshop, rental and/or sharing control or administration or management device, and/or the receiving device. This enables a good topology and/or, in particular therefore, a simplicity of the method. In particular, the reception area may differ from the delivery area at least partially, in particular completely. In addition or alternatively, the receiving device can have a receiving antenna and be designed for wirelessly receiving the identifier, in particular and the operating and/or status data, by means of the receiving antenna, in particular the same one. Further in addition or alternatively, the gateway can comprise the identification and/or enabling control device. Further in addition or alternatively, the number of items of comparison information can be deposited or stored in the identification and/or enabling control device or the identification and/or enabling control device can comprise the database. Further in addition or alternatively, the, in particular transmitted, operating and/or status data and/or the, in particular determined, delivery information may be deposited or stored in the identification and/or enabling control or administration or management device and/or the workshop, rental and/or sharing control or administrative or management device. For further details, reference is also made to the relevant specialist literature.

The in particular electrical system according to the invention is designed or configured to enable a, in particular the, delivery to an, in particular the, delivery point of an, in particular the, motor-driven processing machine and/or an, in particular the, battery pack for supplying an, in particular the, processing machine with electrical drive power. A, in particular the, transmitting device is arranged on and/or in the processing machine and/or the battery pack. The transmitting device is designed or configured for wirelessly transmitting, in particular the, operating and/or status data of the processing machine and/or the battery pack and an, in particular the, identifier. The system is designed or configured: at least for identifying the processing machine and/or the battery pack and/or the transmitting device based on the transmitted identifier. To enable the delivery of the processing machine and/or the battery pack to the delivery point depending on a, in particular the, result of at least the identification. The system can allow at least a part or even all of the advantages as previously mentioned for the method. In particular, the system may be designed or configured to execute, in particular automatically, a method, in particular the method mentioned above. In addition or alternatively, the system can be designed for wirelessly receiving the transmitted identifier, in particular and the transmitted operating and/or status data.

In an extension of the invention, the system comprises or has the processing machine, the battery pack, the transmitting device, in particular the device, and/or the delivery point. In particular, the processing machine, the battery pack, the transmitting device, in particular the device and/or the delivery point, in particular in each case, can be at least partially or even fully designed as previously mentioned for the method. In addition or alternatively, the transmitting device, in particular the device, can be designed for arrangement, in particular mounting, on and/or in the processing machine and/or the battery pack.

Further in addition or alternatively, the system may comprise the database, the receiving device, the gateway, the identification and/or enabling control device, the workshop, rental and/or sharing control device and/or an, in particular electrical, output device. The output device can be designed for outputting the box information and/or the delivery information. In particular, the output device may comprise a display and/or a sound generator.

Further in addition or alternatively, the processing machine, the battery pack, the transmitting device, the delivery point and/or the system, in particular in each case, can be used in a, in particular the, method as described above, in particular to enable a, in particular the, delivery of the processing machine and/or the battery pack to the delivery point.

Further advantages and aspects of the invention are derived from the claims and from the description of exemplary embodiments of the invention, which are explained below by reference to the figure.

### BRIEF DESCRIPTION OF THE DRAWING

FIG. 1 is a schematic diagram of a method according to an embodiment of the invention and a system according to an embodiment of the invention.

### DETAILED DESCRIPTION OF THE DRAWING

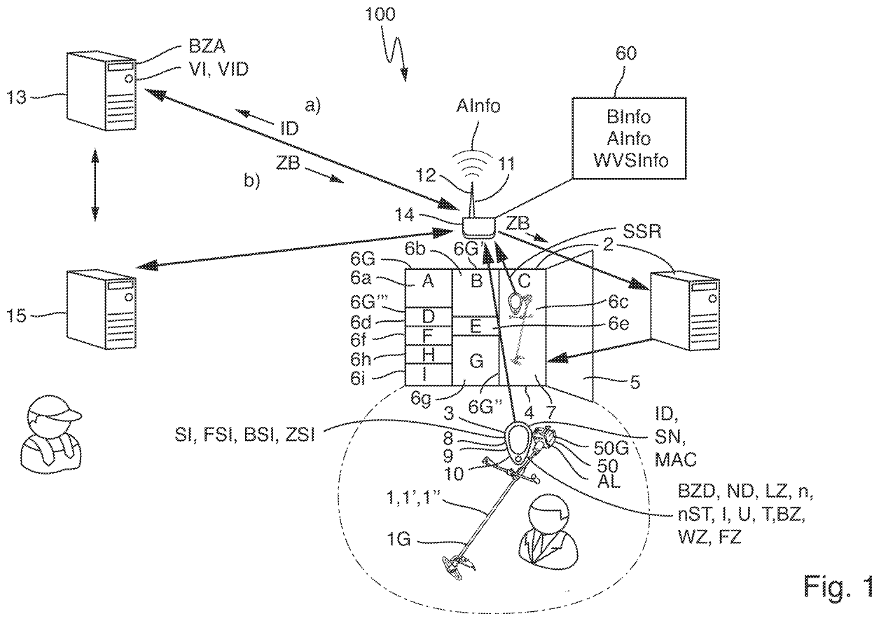

FIG. 1 shows a system 100 and a method for enabling delivery of a motor-driven processing machine 1 and/or a battery pack 50 for supplying the processing machine 1 with electrical drive power AL, to a delivery point 2. A transmitter device 3 is arranged on and/or in the processing machine 1 and/or the battery pack 50. The transmitting device 3 is designed for wirelessly transmitting, and in particular transmits, operating and/or status data BZD of the processing machine 1 and/or the battery pack 50 and an identifier ID.

The system 100 is designed to: at least identify, in particular at least identifies, the processing machine 1 and/or the battery pack 50 and/or the transmitting device 3 based on the transmitted identifier ID; and enable, in particular enables, the delivery of the processing machine 1 and/or the battery pack 50 to the delivery point 2 depending on a result of at least the identification.

The method comprises the steps: a) at least identifying the processing machine 1 and/or the battery pack 50 and/or the transmitting device 3 based on the transmitted identifier ID, in particular by means of the system 100; b) enabling the delivery of the processing machine 1 and/or the battery pack 50 to the delivery point 2 depending on the result of at least the identification, in particular by means of the system 100.

In the exemplary embodiment shown, the processing machine 1 comprises an electric drive motor. In alternative exemplary embodiments, the processing machine can additionally or alternatively comprise an internal combustion drive motor.

Furthermore, in the exemplary embodiment shown, the method comprises: wirelessly transmitting the identifier ID, in particular and the operating and/or status data BZD, in particular by means of the transmitting device 3.

In addition, the system 100 comprises the processing machine 1, the battery pack 50, the transmitting device 3 and/or the delivery point 2.

In detail, the processing machine 1 is a garden, forest, construction and/or ground processing machine 1′.

In the exemplary embodiment shown, the processing unit 1 is a brush cutter 1″. In alternative exemplary embodiments the processing machine can be a saw, a high-level pruner, a hedge trimmer, a hedge cutter, a woodcutter, pruning shears, a blower, a leaf blower, a suction device, a garden vacuum cleaner, a cleaning device, a pressure washer, a spray and/or sprinkler device, a sweeper, a sweeping roller, a brush sweeper, a lawn mower, a grass cutter, a vertical cutter, an angle grinder, or a stone cutter.

The method also comprises: wirelessly receiving the transmitted identifier ID, in particular and the transmitted operating and/or status data BZD, in a reception area 11 of the delivery point 2, in particular by means of a receiving device 12, in particular a gateway 14, in particular of the system 100. The receiving device 12 is arranged in the area of the delivery point 2.

Additionally or alternatively: transmitting the, in particular received, identifier ID to an identification and/or enabling control device 13, in particular of the system 100, in particular from the receiving device 12 and/or via the gateway 14. Step a) and/or step b) is/are performed at least partially by means of the identification and/or enabling control device 13.

Further additionally or alternatively: transmitting an enable command ZB, in particular from the identification and/or enabling control device 13 and/or via the gateway 14, to the delivery point 2, in particular a delivery control device of the delivery point 2.

Further in addition or alternatively, the method is executed by means of the gateway 14, the identification and/or enabling control device 13 and/or the delivery point 2, in particular the delivery control device of the delivery point 2, in particular and a workshop, rental and/or sharing control device 15, in particular of the system 100 and/or of the receiving device 12.

In addition, step a) comprises: verifying an authorisation BZA to enable the delivery based on the transmitted identifier ID, in particular by means of the identification and/or enabling control device 13. Step b) comprises: enabling the delivery depending on a result of the check, in particular by means of the identification and/or enabling control device 13.

Furthermore, step a), in particular the identification and/or checking, comprises: comparing the transmitted identifier ID, or identifier information based on the transmitted identifier, with an in particular stored number of comparison information VI, in particular a number of comparison identifiers VID, in particular by means of the identification and/or enabling control device 13. Step b) comprises: enabling the delivery depending on a result of the comparison, in particular by means of the identification and/or enabling control device 13.

In addition, the delivery point 2 has at least one delivery opening 4 and at least one closure 5 of the delivery opening 4. Step b) comprises: enabling an opening and/or closing of and/or opening and/or closing the closure 5 depending on the result of the identification, in particular by means of the identification and/or enabling control device 13 and/or the delivery point 2.

In the exemplary embodiment shown, the delivery point 2 has nine delivery openings 4 and nine closures 5. In alternative exemplary embodiments, the delivery point may have only one delivery opening and only one closure or at least two, in particular at least five, in particular at least ten, delivery openings and at least two, in particular at least five, in particular at least ten, closures.

Further, the processing machine 1 is made up of a set of processing machines with different machine sizes and/or the battery pack 50 is made up of a set of battery packs with different pack sizes. The delivery point 2 comprises a plurality of delivery boxes 6a, 6b, 6c, 6d, 6e, 6f, 6g, 6h, 6i with different box sizes 6G, 6G′, 6G″, 6G″, 6G′″. The method comprises: allocating a delivery box 6c with a box size 6G″ equal to or greater than a machine size 1G of the processing machine 1, in the exemplary embodiment shown of the brush cutter 1″, and/or a pack size 50G of the battery pack 50 based on the transmitted identifier ID, in particular by means of the identification and/or enabling control device 13 and/or the delivery point 2.

In the exemplary embodiment shown, the delivery point 2 has nine delivery boxes 6a, 6b, 6c, 6d, 6e, 6f, 6g, 6h, 6i and/or four different box sizes 6G, 6G′, 6G″, 6G′″. In alternative exemplary embodiments, the delivery point may comprise at least two, in particular at least five, in particular at least ten, delivery boxes and/or at least two, in particular at least five, in particular at least ten, box sizes.

In addition, the system 100 comprises an output device 60, in the exemplary embodiment shown a display, in particular in the area of the delivery point 2. The output device 60 is designed for outputting, and in particular outputs, in particular visually, box information BInfo related to the allocated delivery box 6c, in particular and the processing machine 1 and/or the battery pack 50 for the delivery box 6c.

In addition or alternatively, the box information BInfo is transmitted, in particular in the area of the delivery point 2, in particular by means of the system 100, in particular the gateway 14.

Further in addition or alternatively, the delivery box 6c comprises the delivery opening 4 and/or the closure 5. The allocated delivery box 6c, in particular its closure 5, is opened, in particular by means of the identification and/or enabling control device 13 and/or the delivery point 2.

Furthermore, the transmitting device 3 is designed for wirelessly transmitting, and in particular transmits, a signal SI comprising the identifier ID, in particular and the operating and/or status data BZD.

In addition, in the exemplary embodiment shown, the method comprises: wireless transmission of the signal SI, in particular by means of the transmitting device 3.

The method further comprises: detecting the delivery by detecting a presence of the processing machine 1 and/or the battery pack 50 within a delivery area 7 of the delivery point 2, in particular the allocated, in particular and opened, delivery box 6c, depending on a receipt of the transmitted signal SI, in particular a signal strength and/or direction SSR or a signal quantity of the received signal SI corresponding to the signal strength and/or direction, in particular by means of the receiving device 12.

In the exemplary embodiment shown, the method comprises: wirelessly receiving the transmitted signal SI, in particular and detecting the signal strength and/or direction SSR or the signal quantity of the received signal SI, in particular by means of the receiving device 12.

In addition, depending on the detected delivery, in particular the detected presence, the closing of the closure 5 is enabled and/or the closure 5 and/or the in particular open delivery box 6c, is/are closed.

The method further comprises: determining delivery information AInfo, in particular workshop, rental and/or sharing information WVSInfo, which can be comprehended in particular by the deliverer, based on the transmitted operating and/or status data BZD, in particular by means of the system 100, in particular the workshop, rental and/or sharing control device 15; outputting and/or transmitting the determined delivery information AInfo, in particular in the area of the delivery point 2 and/or during the delivery, in particular by means of the output device 60 and/or the system 100, in particular the gateway 14.

In the exemplary embodiment shown, the output device 60 is designed for outputting, and in particular outputs, the delivery information AInfo, in particular visually.

In addition, a device 8 is arranged on and/or in the processing machine 1 and/or the battery pack 50. The device 8 comprises an acquisition and/or evaluation device 9, in particular and a determination device 10, and the transmitting device 3. The acquisition and/or evaluation device 9 is designed to acquire at least one operating variable, the operating variable being dependent on an operating state of the processing machine 1 and/or the battery pack 50, and to evaluate the acquired operating variable for determining the operating data BD. In addition or alternatively, the acquisition and/or evaluation device 9 is designed to acquire the operating data BD. The determination device 10 is designed for determining the status data ZD of the processing machine 1 and/or the battery pack 50 based on the determined and/or acquired operating data BD.

In the exemplary embodiment shown, the system 100 comprises the device 8.

Furthermore, the operating and/or status data BZD comprises utilization data ND and/or a runtime LZ and/or rotation speed n, in particular a rotation speed statistics nST, and/or a current I and/or a voltage U and/or a temperature T and/or a determination state BZ and/or a maintenance state WZ and/or a fault status FZ.

In addition, the identifier ID comprises a serial number SN and/or a MAC address MAC. In particular, the identifier ID is a serial number SN and/or a MAC address MAC.

Furthermore, the signal SI is a radio signal FSI, in particular a Bluetooth Low Energy signal BSI and/or a ZigBee signal ZSI, and/or having a short range, in particular a maximum range of 10 m.

Furthermore, the delivery point 2, in particular the delivery control device of the delivery point 2, the receiving unit 12, the identification and/or enabling control device 13, the gateway 14, the workshop, rental and/or sharing control device 15 and/or the output device 60, are interconnected, in particular via the gateway 14, in particular for communication purposes.

As the exemplary embodiments shown and explained above make clear, the invention provides a method and a system for enabling a delivery of a motor-driven processing machine and/or a battery pack for supplying a processing machine with electrical drive power at a delivery point, wherein the method and the system, in particular in each case, have improved properties.

What is claimed is:

1. A method for enabling a delivery of a motor-driven processing machine and/or a battery pack for supplying a processing machine with electrical drive power at a delivery point, wherein a transmitting device is arranged on and/or in the processing machine and/or the battery pack, the transmitting device being designed for wireless transmission of operating and/or status data of the processing machine and/or the battery pack and an identifier,
the method comprising the steps of:
a) at least identifying at least one of the processing machine, the battery pack, or the transmitting device, based on the transmitted identifier; and
b) enabling the delivery of the processing machine and/or the battery pack at the delivery point depending on a result of the identification.

2. The method according to claim 1,
wherein step a) comprises: checking an authorization to enable the delivery based on the transmitted identifier, and
wherein step b) comprises: enabling the delivery depending on a result of the check.

3. The method according to claim 1,
wherein step a) comprises: comparing the transmitted identifier, or identifier information based on the transmitted identifier, with a number of comparison information, and
wherein step b) comprises: enabling the delivery depending on a result of the comparison.

4. The method according to claim 1,
wherein the delivery point has at least one delivery opening and at least one closure of the delivery opening,
wherein step b) comprises: enabling opening and/or closing of, and/or opening and/or closing, the closure depending on the result of the identification.

5. The method according to claim 1,
wherein the processing machine is made up of a set of processing machines with different machine sizes and/or the battery pack is made up of a set of battery packs with different pack sizes,
wherein the delivery point comprises a plurality of delivery boxes with different box sizes,
wherein the method further comprises:
allocating a delivery box with a box size equal to or greater than a machine size of the processing machine and/or a pack size of the battery pack based on the transmitted identifier.

6. The method according to claim 5,
wherein the transmitting device is designed for the wireless transmission of a signal comprising the identifier,
wherein the method comprises:
detecting the delivery by detecting a presence of the processing machine and/or the battery pack within the allocated delivery box, depending on a signal strength and/or direction (SSR) or a signal quantity of the received signal (SI) corresponding to the signal strength and/or direction (SSR).

7. The method according to claim 1,
wherein the transmitting device is designed for the wireless transmission of a signal (SI) comprising the identifier (ID),
wherein the method comprises:
detecting the delivery by detecting a presence of the processing machine and/or the battery pack within a delivery area of the delivery point depending on a reception of the transmitted signal.

8. The method according to claim 1,
wherein the processing machine is a garden, forestry, construction and/or ground processing machine.

9. The method according to claim 1,
wherein the processing machine is a saw, a high-level pruner, a hedge trimmer, a hedge cutter, a woodcutter, pruning shears, a blower, a leaf blower, a suction device, a garden vacuum cleaner, a cleaning device, a pressure washer, a spray and/or sprinkler device, a sweeper, a sweeping roller, a brush sweeper, a lawn mower, a grass cutter, a vertical cutter, a brush saw, an angle grinder or a stone cutter.

10. The method according to claim 1, further comprising:
determining delivery information of a workshop, rental and/or sharing information, which is comprehendible by the deliverer, based on the transmitted operating and/or status data; and
outputting and/or transmitting the determined delivery information in the area of the delivery point and/or during the delivery.

11. The method according to claim 1,
wherein a device is arranged on and/or in the processing machine and/or the battery pack, wherein the device comprises:
an acquisition and/or evaluation device, wherein the acquisition and/or evaluation device is designed for acquiring at least one operating variable, the operating variable being dependent on an operating state of the processing machine and/or the battery pack, and for evaluating the acquired operating variable to determine the operating data, and/or for acquiring the operating data,
a determination device, the determination device being designed for determining the status data of the processing machine and/or of the battery pack based on the determined and/or acquired operating data, and
the transmitting device.

12. The method according to claim 1,
wherein the operating and/or status data have at least one of: utilization data, a runtime, a rotation speed, rotation speed statistics, a current, a voltage, a temperature, a determination state, a maintenance state, or a fault status.

13. The method according to claim 1,
wherein the identifier comprises a serial number and/or a MAC address.

14. The method according to claim 1,
wherein the transmitting device is designed for the wireless transmission of a signal comprising the identifier,
wherein the signal is a Bluetooth Low-Energy signal, a ZigBee signal, and/or has a short range at a maximum of 10 m.

15. The method according to claim 1,
wherein the method comprises at least one of:
(i) wirelessly receiving the transmitted identifier in a reception area of the delivery point by way of a receiving device, the receiving device being arranged in the area of the delivery point,
(ii) transmitting the identifier to an identification and/or enabling control device, and wherein step (a) and/or step (b) is/are performed at least in part by way of the identification and/or enabling control device,
(iii) transmitting an enable command, in particular from an identification and/or enabling control device, to the delivery point, or
(iv) wherein the method is carried out by way of a gateway, an identification and/or enabling control device and/or the delivery point, and a workshop, rental and/or sharing control device.

16. A system for enabling a delivery of a motor-driven processing machine and/or a battery pack for supplying a processing machine with electrical drive power to a delivery point, comprising:
a transmitting device arranged on and/or in the processing machine and/or the battery pack, the transmitting device being designed for wireless transmission of operating and/or status data of the processing machine and/or the battery pack and of an identifier,
wherein the system is operating configured to:
at least to identify the processing machine and/or the battery pack and/or the transmitting device based on the transmitted identifier, and
enable the delivery of the processing machine and/or the battery pack at the delivery point depending on a result of at least the identification.

17. The system according to claim 16,
wherein the system comprises the processing machine, the battery pack, the transmitting device and/or the delivery point.
